(19) United States
(12) Patent Application Publication
(10) Pub. No.: US 2006/0137800 A1
(43) Pub. Date: Jun. 29, 2006

(54) Method for continuously making foamed rubber material with texture thereon

(76) Inventor: Semi Kao, Chang-Hua Hsien (TW)

Correspondence Address: BRUCE H. TROXELL, SUITE 1404, 5205 LEESBURG PIKE, FALLS CHURCH, VA, 22041, US

(21) Appl. No.: 10/934,538

(22) Filed: Dec. 23, 2004

(51) Int. Cl. B32B 37/00

(52) U.S. Cl. 156/79; 156/538

(57) ABSTRACT

A method for making the foamed rubber material with a texture thereon has the steps of a) Well mix a raw material, wherein the raw material has a rubber, a blowing agent and an accelerator etc. b) Press the raw material into a rubber sheet. c) Soften and heat a surface of the rubber sheet. d) Attach and press a surface layer on the surface of the rubber sheet to have an unfoamed rubber material. e) Vulcanize and foam the unfoamed material and forming a texture on a side thereof.

### BACKGROUND OF THE INVENTION

1. Field of the Invention

The present invention relates generally to a method for making foamed rubber materials, and more particularly to a method, which continuously making the rubber foamed sheet with a texture thereon.

2. Description of the Related Art

The conventional methods for making the foamed rubber sheet include continuous extrusion process and molding process. The first method has the steps of providing the well-mixed raw material to an extruding machine to form a rubber sheet. The rubber sheet is to a foaming machine via the band conveyer for vulcanization and foaming. The second method provides the raw material in a die and heats and pressurizes it for molding. The first method is faster in fabrication of foamed rubber material than the second method and is cheaper, so that the foamed rubber sheets usually are made by the continuous extrusion process in the present industry.

But the continuous extrusion process only makes the foamed rubber sheets with a flat surface that couldn't meet the requirement of the foamed rubber sheets having various textures thereon in the present market. The relative manufacturers are working on how to fabricate the foamed rubber sheet, on which a surface layer is attached or a texture is provided.

The conventional method of attaching a surface layer on the foamed rubber sheet has the steps of coating glue on the rubber sheet and attaching a surface layer thereon before foaming, and then the foamed rubber sheet with the surface layer is sent to the foaming machine for vulcanization and foaming. The conventional method of making the foamed rubber sheet with a texture thereon has the steps of attaching a temporary layer via glue on the rubber sheet before foaming. The temporary layer has a predetermined texture on a side thereof and the side is attached on the rubber sheet. After foaming, the temporary layer is peeled and a texture is left on the surface of the foamed rubber sheet.

The aforesaid methods provide pollution because of the glue. The texture of the temporary layer is worn after several times of use and it has to be replaced. In mass produce, there are lots of waste temporary layers generated. The step of peeling the temporary layer slows down the speed of fabrication.

### SUMMARY OF THE INVENTION

The primary objective of the present invention is to provide a method of continuously making the foamed rubber materials, in which no glue is provided in the process and no temporary layer is peeled in the process.

According to the objective of the present invention, a method for making the foamed rubber material, comprises the steps of:

a) Well mix a raw material, wherein the raw material has a rubber, a blowing agent and an accelerator with a predetermined ratio.

b) Press the raw material into a rubber sheet.

c) Soften a surface of the rubber sheet.

d) Attach and pressing a surface layer on the surface of the rubber sheet to have an unfoamed rubber material.

e) Vulcanize and foam the unfoamed material and forming a texture on a side thereof.

### BRIEF DESCRIPTION OF THE DRAWINGS

FIG. 1 is a flow chart of a preferred embodiment of the present invention, and

FIG. 2 is a sectional view of the preferred embodiment of the present invention, showing the rubber sheet and the surface layer being foamed.

### DETAILED DESCRIPTION OF THE INVENTION

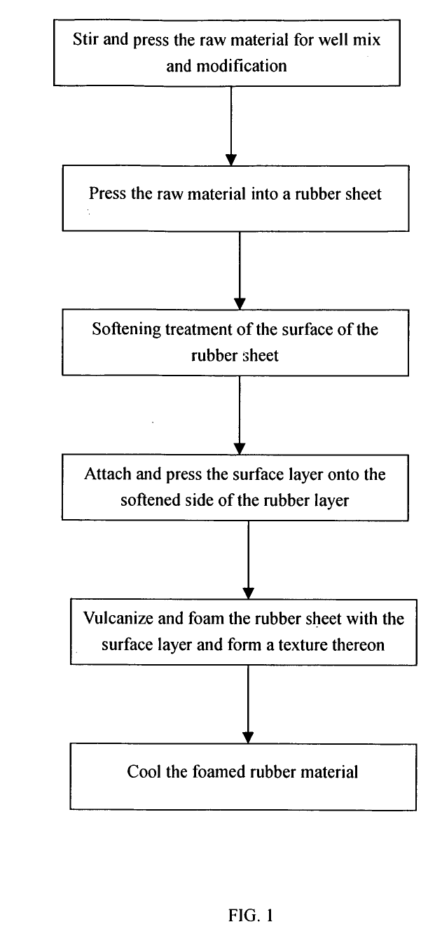

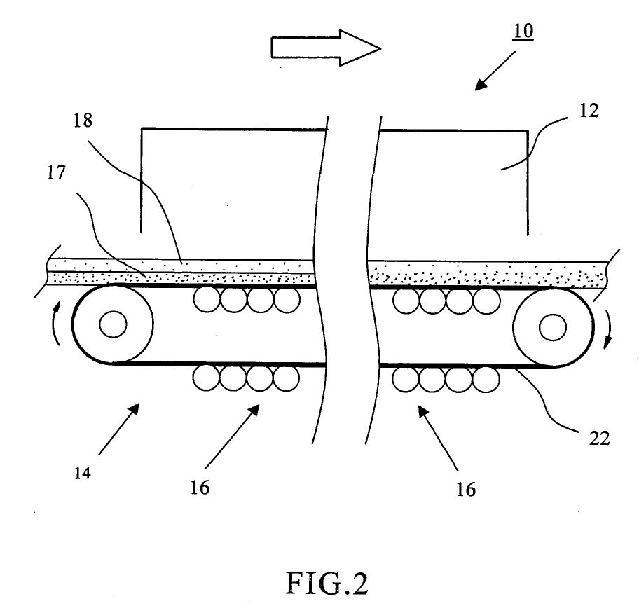

As shown in FIGS. from FIG. 1 to FIG. 2, a method for continuously making a foamed rubber material of the preferred embodiment of the present invention comprises the steps of:

a) Provide a raw material, which includes rubber, blowing agent and accicure (TMT) etc., into a stirring machine for pressing and stirring the raw material, and then provide the raw material to a mixing machine for mixing modification.

The raw material has a natural rubber, an artificial flexible material (styrene butadiene rubber (SBR), butadiene rubber (BR), ethylene propylene rubber (EPDM, and so on), a curing agent (sulfur), an organic blowing agent (azodicarbonamide (ADCA)), an accicure (TMT, TMTD, MBT and so on), a filler or a reinforcement and an additive (rubber grade carbon black, fumed silica, calcium silicate (CaSiO₃), calcium carbonate (CaCO₃) and so on). The ratio of the natural rubber and the artificial flexible material is 4:1.

b) Press the well-mixed raw material into a rubber sheet. A sheet pressing machine is applied to the present step.

c) Soften a surface of the rubber sheet. In this step, a surface softening agent is coated onto the surface of the rubber sheet, and then heat the rubber sheet to have a surface temperature of 150° C. to 250° C. The surface softening agent is well known in the relative field to soften the rubber products. It also ca applies infrared rays to soften the rubber sheet.

d) Attach a surface layer onto the softened surface of the rubber sheet, and then press the surface layer to have an unfoamed rubber material. The surface layer is made of a material different from a material of the rubber sheet in components and in physical capacities.

e) Send the unfoamed rubber material into a molding machine for vulcanization and foaming to have a foamed material. The foamed material is rolled. A pressure generated from a chemical reaction of foaming makes the surface layer bonded on the rubber sheet firmly. The molding machine also provides the foamed material a texture.

The molding machine 10 is similar to a conventional machine for vulcanization and foaming, which has a box 12 for vulcanization and foaming and a conveyer unit 14, which is made of metal and has a band-like texture member 22. The texture member 22 has a woven texture on a surface. The molding machine 10 further has a supporting unit 16 to support the texture member 22 to carry the rubber sheet. After the rubber sheet 17 with the surface layer 18 is sent to the molding machine 10 for vulcanization and foaming, the texture member 22 forms a texture on a side of the foamed material.

The foamed material is cooled in a normal environment to have a foamed rubber material with the texture on a side thereof.

The machines mentioned in the preferred embodiment are conventional machines, they are not the main character of the present invention, so that I do not describe the detail of the machines.

The present invention uses the pressure generated from the chemical reaction of foaming to bond the surface layer on the rubber sheet firmly, so that no glue is needed in the method of the present invention and there is no pollution because of the glue. The texture member 22 of the molding machine 10, which makes the foamed rubber material with a texture, is not easy to be worn, so that it doesn't need for replacement frequently and no peeling action is needed in the present method. The method of the present invention overcomes all of the drawbacks of the conventional methods.

The surface layer can be a fabric or a plastic film etc. to provide the foamed rubber material having various applications. The molding machine could provide two texture members therein to provide texture on both side of the foamed rubber material.

In conclusion, no glue is needed in the method to bond the surface layer on the rubber sheet that avoids the pollution because of the glue and no peeling step is needed too. The present invention overcomes all of the drawbacks of the conventional methods.

What is claimed is:

1. A method, comprising the steps of:
a) well mixing a raw material, wherein the raw material has a rubber, a blowing agent and an accelerator with a predetermined ratio;
b) pressing the raw material into a rubber sheet;
c) softening a surface of the rubber sheet;
d) attaching and pressing a surface layer on the surface of the rubber sheet to have an unfoamed rubber material, and
e) vulcanizing and foaming the unfoamed material and forming a texture on a side thereof.

2. The method as defined in claim 1, wherein the foaming agent is an organic blowing agent.

3. The method as defined in claim 1, wherein the texture is formed on a surface of the rubber sheet.

4. The method as defined in claim 1, wherein the raw material is sent to a stirring machine for stirring and pressing repeatedly, and then is sent to a mixing machine for mixing modification in the step a.

5. The method as defined in claim 1, wherein a surface softening agent is coated on the surface of the rubber sheet before the surface layer is attached in the step c.

6. The method as defined in claim 1, further comprising heating the rubber sheet in a range between 150° C. and 250° C. in the step c.

7. The method as defined in claim 3, wherein the surface layer is a rubber film, which is made of a material as same as a material of the rubber sheet.

8. The method as defined in claim 7, wherein the surface layer is a rubber film, which is made of a material different from a material of the rubber sheet.

9. The method as defined in claim 3, wherein the surface layer is a fabric.

10. The method as defined in claim 3, wherein the surface layer is a plastic film.

11. A machine for making a foamed rubber material with a texture thereon, comprising:
a box for vulcanization and foaming, and
a conveyer unit for sending an unfoamed rubber material into the box for vulcanization and foaming and sending it out of the box, wherein the conveyer unit has a band-like metallic texture member, on which the rubber material is rest for movement.

12. The machine as defined in claim 11, wherein the conveyer unit further has a supporting unit mounted at a bottom side of the texture member to support the texture member.

13. The machine as defined in claim 11, wherein the texture member has a texture on a side thereof.
